(19) United States
(12) Patent Application Publication
(10) Pub. No.: US 2018/0044603 A1
(43) Pub. Date: Feb. 15, 2018

(54) METHOD FOR MANUFACTURING ASHLESS COAL

(71) Applicant: KABUSHIKI KAISHA KOBE SEIKO SHO (KOBE STEEL, LTD.), Kobe-shi, Hyogo (JP)

(72) Inventors: Koji SAKAI, Hyogo (JP); Noriyuki OKUYAMA, Hyogo (JP); Takuya YOSHIDA, Hyogo (JP); Shigeru KINOSHITA, Hyogo (JP)

(73) Assignee: Kabushiki Kaisha Kobe Seiko Sho (Kobe Steel, Ltd.), Kobe-shi, Hyogo (JP)

(21) Appl. No.: 15/552,533

(22) PCT Filed: Feb. 19, 2016
(86) PCT No.: PCT/JP2016/054933

§ 371 Date: Aug. 22, 2017

(30) Foreign Application Priority Data
Mar. 6, 2015 (JP) 2015-044799

(51) Int. Cl. C10L 9/08; B01D 46/40

(52) U.S. Cl. CPC C10L 9/08; B01D 46/403; C10L 5/06

(57) ABSTRACT

A method for producing an ash-free coal includes a step of mixing a coal with a solvent to prepare a slurry; a step of dissolving away a coal component soluble in the solvent, from the coal, by heating the slurry; a step of separating the solution containing the coal component dissolved therein from the slurry after the dissolution; and a step of subjecting the solution separated in the separation step to a vaporization and a separation of the solvent to obtain an ash-free coal. The separation step and the dissolution step are simultaneously performed.

### TECHNICAL FIELD

The present invention relates to a method for producing an ash-free coal.

### BACKGROUND ART

Coals are extensively utilized as fuels for thermal electric-power generation or boilers or as starting materials for chemical products, and there is a strong desire to develop a technique for efficiently removing the ash matter contained in coals, as an environmental countermeasure. For example, in a high-efficiency combined electric-power generation system based on gas turbine combustion, an attempt is being made to use an ash-free coal (HPC) from which ash matter has been removed, as a fuel that replaces liquid fuels including LNG. It is also attempted to use an ash-free coal as a raw material coal for steelmaking cokes, such as cokes for blast furnaces.

Proposed as a method for producing an ash-free coal is a method in which a solution containing coal components soluble in solvents (hereinafter referred to also as “solvent-soluble components”) is separated from a slurry by using a gravitational settling method (for example, JP-A-2009-227718). This method includes a slurry preparation step in which a coal is mixed with a solvent to prepare a slurry and an extraction step in which the slurry obtained in the slurry preparation step is heated to extract solvent-soluble components. This method further includes: a solution separation step in which a solution containing the solvent-soluble components dissolved therein is separated from the slurry in which the solvent-soluble components have been extracted in the extraction step; and an ash-free-coal acquisition step in which the solvent is separated from the solution separated in the solution separation step, thereby obtaining an ash-free coal.

In the extraction step in a conventional method for ash-free coal production, the slurry obtained in the slurry preparation step is heated to a given temperature and supplied to an extraction tank. The slurry supplied to the extraction tank is held at a given temperature while being stirred with a stirrer, thereby extracting solvent-soluble components. In this extraction step, the slurry is allowed to stay in the extraction tank for about 10-60 minutes in order to sufficiently dissolve the solvent-soluble components into the solvent.

In the conventional method for ash-free coal production described above, there are cases where the solvent-soluble components in the extraction step polymerize due to the temperature elevation to become a residue, and they are not extracted as solvent-soluble components in the solvent separation step. There is hence a possibility that the extraction rate of ash-free coal might decrease. The term “extraction rate” means the proportion of the mass of an ash-free coal produced with respect to the mass of the coal used as a raw material.

### PRIOR ART DOCUMENT

### Patent Document

Patent Document 1: JP-A-2009-227718

### SUMMARY OF THE INVENTION

### Problem that the Invention is to Solve

The present invention has been achieved under the circumstances described above, and an object thereof is to provide a method for producing an ash-free coal, the method attaining a high extraction rate of ash-free coal.

### Means for Solving the Problem

The invention, which has been achieved in order to solve the problem described above, is a method for producing an ash-free coal, including a step of mixing a coal with a solvent to thereby prepare a slurry, a step of dissolving away a coal component soluble in the solvent, from the coal, by heating the slurry, a step of separating a solution containing the coal component dissolved therein, from the slurry after the dissolution, and a step of subjecting the solution separated in the separation step to a vaporization and a separation of the solvent to thereby obtain an ash-free coal, in which the separation step and the dissolution step are simultaneously performed.

Since the separation step and the dissolution step in this method for producing an ash-free coal are simultaneously conducted, the polymerization of solvent-soluble components due to a temperature elevation in the separation step is less apt to occur and the dissolved amount of solvent-soluble components can be increased in the dissolution step. Consequently, this method for producing an ash-free coal is capable of heightening the extraction rate of ash-free coal.

It is desirable that the separation step should be performed during a temperature rising in the dissolution step. By thus performing the separation step during temperature rising in the dissolution step, the polymerization of solvent-soluble components due to a temperature elevation can be further inhibited and the extraction rate of ash-free coal is further heightened.

It is desirable to perform the separation step as a continuous treatment. In the case when the separation step is performed as a continuous treatment, the solvent-soluble components are not made to stay in a reservoir tank or the like and the polymerization of the solvent-soluble components due to a temperature elevation can be more inhibited. Hence, the extraction rate of ash-free coal is further heightened.

It is desirable that in the separation step, a solid-liquid separator equipped with a filter cylinder and a helical channel disposed along an inner side surface of the filter cylinder should be used. By using this solid-liquid separator in the separation step, the apparatus to be used in the separation step can be simplified and the cost of the apparatus for producing an ash-free coal can be reduced. Furthermore, since a solution containing coal components dissolved therein is separated by filtration through the filter cylinder, ash matter concentration of the ash-free coal obtained can be reduced.

It is desirable that the filter cylinder should be a meshy one including a metal wire. In the case when a meshy one including metal wires is used as the filter cylinder, the filter is less apt to suffer clogging and requires no supporting material such as a reinforcing wire. Consequently, a solution containing coal components dissolved therein can be easily and reliably separated.

It is desirable that the solid-liquid separator should be further equipped with a recovery pipe that includes the filter cylinder and recovers the solution, and that the recovery pipe should have a recovery hole, which discharges the solution, in a side face thereof at an upstream side of the helical channel. The solution has a higher temperature in the downstream side. By thus disposing the recovery hole in the side face at an upstream side of the helical channel, the solution on the downstream side, which has a higher temperature, is recovered while moving toward the upstream side of the helical channel. Because of this, heat exchange occurs between this solution and the slurry which passes through the helical channel, making it possible to improve the efficiency of heating the slurry which passes through the helical channel.

It is desirable that a plurality of such solid-liquid separators connected serially should be used and a heating temperature of the plurality of solid-liquid separators should be set for each of the solid-liquid separators. By thus setting a heating temperature of the solid-liquid separators for each of the solid-liquid separators, components to be dissolved away in each of the solid-liquid separators can be varied. Thus, components differing in molecular weight distribution, components differing in softening point or meltability, and the like can be easily separated and obtained.

It is desirable that the heating temperature of the plurality of solid-liquid separators should be set to be higher toward a downstream side. By thus setting the heating temperature of the plurality of solid-liquid separators to be higher toward the downstream side, coal components soluble in the solvent at each of the heating temperatures can be successively separated. As a result, the polymerization of the solvent-soluble components can be more inhibited and the extraction rate of ash-free coal is further heightened.

The ash-free coal (Hyper-coal; HPC) is a kind of modified coal obtained by modifying a coal, and is a modified coal obtained by removing ash matter and insoluble components as much as possible from a coal by using a solvent. However, the ash-tree coal may contain ash matter unless the flowability or expansibility of the ash-free coal is considerably impaired thereby. Although coals generally contain an ash matter in a content of 7% by mass or more and 20% by mass or less, ash-free coals may contain an ash matter in a content of about 2% by mass and, in some cases, about 5% by mass. The term “ash matter” means a value measured in accordance with JIS-M8812:2004.

### Effect of the Invention

As explained above, the method of the present invention for producing an ash-free coal is capable of heightening the extraction rate of ash-free coal by performing a separation step simultaneously with a dissolution step.

### BRIEF DESCRIPTION OF THE DRAWINGS

FIG. 1 is a diagrammatic view illustrating an ash-free coal production apparatus for use in a method for ash-free coal production as a first embodiment of the present invention.

FIG. 2 is a diagrammatic view illustrating the solid-liquid separator of the ash-free coal production apparatus of FIG. 1.

FIG. 3 is a diagrammatic view illustrating an ash-free coal production apparatus according to an embodiment differing from that of FIG. 1.

### MODES FOR CARRYING OUT THE INVENTION

Embodiments of the method for ash-free coal production according to the present invention are explained below in detail.

### First Embodiment

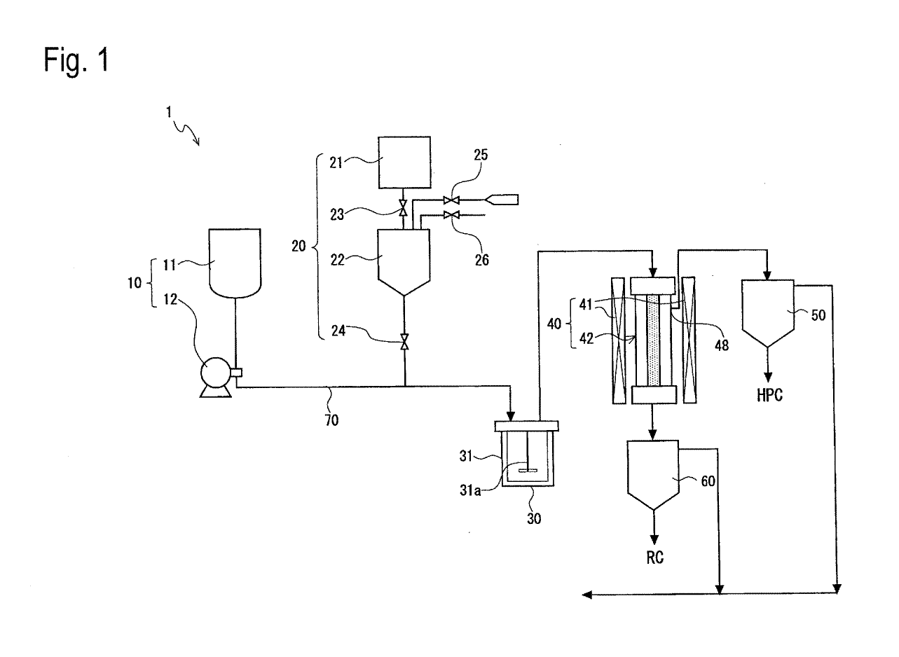

The ash-free coal production apparatus 1 in FIG. 1 mainly includes a solvent feed part 10, a coal feed part 20, a preparation part 30, a solid-liquid separation part 40, a first solvent separation part 50, and a second solvent separation part 60.

### <Solvent Feed Part>

The solvent feed part 10 feeds a solvent to the preparation part 30. As illustrated in FIG. 1, the solvent feed part 10 mainly includes a solvent tank 11 and a pump 12.

### (Solvent Tank)

The solvent tank 11 stores therein a solvent to be mixed with a coal to be fed from the coal feed part 20. The solvent to be mixed with the coal is not particularly limited so long as the coal dissolves therein. For example, coal-derived bicyclic aromatic compounds are suitably used. Since the bicyclic aromatic compounds are akin in basic structure to the structural molecules of coals, the bicyclic aromatic compounds have a high affinity for coals and a relatively high extraction rate can be obtained therewith.

Examples of the coal-derived bicyclic aromatic compounds include methylnaphthalene oil and naphthalene oil, which are distillate oils of by-product oils yielded when a coke is produced by coal carbonization.

The solvent is not particularly limited in the boiling point thereof. For example, a lower limit of the boiling point of the solvent is preferably 180° C., more preferably 230° C. Meanwhile, an upper limit of the boiling point of the solvent is preferably 300° C., more preferably 280° C. In the case where the boiling point of the solvent is below the lower limit, there is a possibility that when the solvent is recovered in an ash-free coal acquisition step of vaporizing the solvent to obtain an ash-free coal, the loss due to volatilization might increase and hence the solvent recovery rate might decrease. Conversely, in the case where the boiling point of the solvent exceeds the upper limit, it is difficult to separate the solvent-soluble components from the solvent and there is a possibility in this case also that the solvent recovery rate might decrease.

### (Pump)

The pump 12 is provided to a pipeline connecting to the preparation part 30. The pump 12 compression-transports a solvent stored in the solvent tank 11 to the preparation part 30 through a feed pipe 70.

The kind of the pump 12 is not particularly limited so long as it can compression-transport the solvent to the preparation part 30 through the feed pipe 70. For example, a displacement pump or a non-displacement pump can be used. More specifically, a diaphragm pump or a tubephragm pump can be used as the displacement pump, and a vortex pump or the like can be used as the non-displacement pump.

### <Coal Feed Part>

The coal feed part 20 feeds a coal to the preparation part 30. The coal feed part 20 includes a normal-pressure hopper 21 used in a normal-pressure state, a pressure hopper 22 used either in a normal-pressure state or in a pressurized state, a first valve 23 provided to a pipeline connecting the normal-pressure hopper 21 and the pressure hopper 22, and a second valve 24 provided to a pipeline connecting the pressure hopper 22 and the feed pipe 70. A pressurization line 25 that supplies a gas such as nitrogen gas and a gas discharge line 26 that discharges the gas are connected to the pressure hopper 22.

The coal stored in the normal-pressure hopper 21 is first transported to the pressure hopper 22 by opening the first valve 23 while keeping the second valve 24 closed. In this stage, the pressure hopper 22 is in a normal-pressure state. Next, the first valve 23 is closed, and a gas such as nitrogen gas is supplied to the pressure hopper 22 through the pressurization line 25. As a result, the pipeline extending from the first valve 23 to the second valve 24 and including the pressure hopper 22 is pressurized, and the inside of the pressure hopper 22 comes to be a pressurized state. It is preferable in this operation that pressurization is performed so that the pressure inside the pressure hopper 22 becomes equal to or higher than the pressure inside the feed pipe 70. The second valve 24 is then opened, thereby feeding the coal within the pressure hopper 22 to the feed pipe 70. By thus bringing the inside of the pressure hopper 22 into a pressurized state, the coal within the pressure hopper 22 is smoothly fed to the feed pipe 70. In the coal feed part 20 of FIG. 1, the pressurization line 25 and the gas discharge line 26 are connected to the pressure hopper 22, but they may be connected to, for example, a pipeline other than the pressure hopper 22, as long as it is between the first valve 23 and the second valve 24.

The kinds of the first valve 23 and the second valve 24 are not particularly limited. For example, a gate valve, ball valve, flap valve, rotary valve, or the like can be used as the first valve 23 and the second valve 24.

As the coal to be fed from the coal feed part 20, coals of various qualities can be used. For example, bituminous coal, which shows a high extraction rate, and less expensive low-rank coals (sub-bituminous coal and brown coal) are suitably used. In the case where a coal is classified by particle size, finely ground coals are suitably used. The term “finely ground coal” means a coal in which the proportion by mass of coals having a particle size less than 1 mm with respect to the total mass of the coals is, for example, 80% or higher. A lump coal can also be used as the coal to be fed from the coal feed part 20. The term “lump coal” herein means a coal in which the proportion by mass of coals having a particle size of 5 mm or larger with respect to the total mass of the coals is, for example, 50% or higher. Since lump coals have larger coal particle sizes than the finely ground coals, the efficiency of separation in the separation step can be heightened. The term “particle size (particle diameter)” herein means a value measured in accordance with JIS-Z8815(1994); Test sieving, General requirements. For classifying coals by particle size, use can be made, for example, of metal wire cloth as provided for in JIS-Z-8801-1(2006).

From the standpoint of attaining a reduction in dissolution period, it is preferable that one including a low-rank coal in a large amount should be used as the coal to be fed from the coal feed part 20. A lower limit of the proportion of the low-rank coal to the whole amount of coal to be fed is preferably 80% by mass, more preferably 90% by mass. In the case where the proportion of the low-rank coal included in the coal to be fed is less than the lower limit, there is a possibility that the time period for dissolving away solvent-soluble components might be prolonged.

A lower limit of the carbon content of the low-rank coal is preferably 70% by mass. An upper limit of the carbon content of the low-rank coal is preferably 85% by mass, more preferably 82% by mass. In the case where the carbon content of the low-rank coal is less than the lower limit, there is a possibility that the dissolution rate of solvent-soluble components might decrease. Conversely, in the case where the carbon content of the low-rank coal exceeds the upper limit, there is a possibility that the cost of the coal to be fed might increase.

As the coal to be fed from the coal feed part 20 to the preparation part 30, a coal which has been slurried by adding a small amount of a solvent may be used. By feeding a slurried coal from the coal feed part 20 to the preparation part 30, the coal is rendered easy to mix with a solvent in the preparation part 30 and the coal can be dissolved more rapidly. However, in the case where the amount of a solvent mixed for the slurrying is large, the heat quantity for temperature-rising of the slurry in the solid-liquid separation part 40 to a dissolution temperature becomes unnecessarily large, and there is hence a possibility of heightening the production cost.

### <Preparation Part>

In the preparation part 30, the solvent fed from the solvent feed part 10 is mixed with the coal fed from the coal feed pat 20, thereby obtaining a slurry. The preparation part 30 includes a preparation tank 31.

### (Preparation Tank)

To the preparation tank 31 are fed the solvent and the coal through the feed pipe 70. The preparation tank 31 mixes the fed solvent and coal to produce a slurry, and retains this slurry. The preparation tank 31 has a stirrer 31a. The preparation tank 31 retains the mixed slurry therein while stirring with the stirrer 31a, thereby maintaining the mixed state of the slurry.

A lower limit of the coal concentration, on dry coal basis, of the slurry in the preparation tank 31 is preferably 10% by mass, more preferably 13% by mass. Meanwhile, an upper limit of the coal concentration is preferably 25% by mass, more preferably 20% by mass. In the case where the coal concentration is less than the lower limit, there is a possibility that the dissolved amount of the solvent-soluble components might be too small with respect to the treated amount of the slurry, resulting in a decrease in the efficiency of ash-free coal production. Conversely, in the case where the coal concentration exceeds the upper limit, there is a possibility that the solvent-soluble components might saturate the solvent, resulting in a decrease in the dissolution rate of solvent-soluble components. It is therefore preferable that a solvent should be fed from the solvent feed part 10 in such an amount that the proportion of the coal fed from the coal feed part 20 to the sum of the coal and the solvent fed from the solvent feed part 10 is within the coal concentration range shown above.

### <Solid-Liquid Separation Part>

In the solid-liquid separation part 40, the slurry is heated to dissolve away solvent-soluble components from the coal and a solution containing the coal components dissolved therein is separated from the slurry after the dissolution. The solid-liquid separation part 40 mainly includes a heater 41 and a solid-liquid separator 42.

### (Heater)

The heater 41 heats the slurry that passes through the inside of the solid-liquid separator 42. The heater 41 is hence disposed on the outer side of the solid-liquid separator 42 along the solid-liquid separator 42. Some of the pipeline on upstream side from the solid-liquid separator 42 may be heated with the heater 41 in order that the temperature of the slurry flowing into the solid-liquid separator 42 be elevated to a desired temperature beforehand. By this heating, solvent-soluble components are dissolved away from the coal.

The heater 41 is not particularly limited so long as it can heat the slurry that passes through the inside of the solid-liquid separator 42. Examples thereof include a resistance heating heater and an induction heating coil. Heating may be conducted by using a heat medium. For example, a heating tube is disposed around the solid-liquid separator 42 and a heat medium, such as steam or oil, is supplied to this heating tube. Thus, the slurry that passes through the inside of the solid-liquid separator 42 can be heated.

A lower limit of the temperature of the slurry after the heating by the heater 41 is preferably 300° C., more preferably 350° C. Meanwhile, an upper limit of the temperature of the slurry is not particularly limited so long as it is a temperature at which dissolution is possible, but it is preferably 420° C., more preferably 400° C. In the case where the temperature of the slurry is below the lower limit, there is a possibility that the bonds between the molecules constituting the coal cannot be sufficiently weakened, resulting in a decrease in the dissolution rate. Conversely, in the case where the temperature of the slurry exceeds the upper limit, the heat quantity for maintaining such a slurry temperature becomes unnecessarily large, and there is hence a possibility of heightening the production coat.

The heater 41 heats the slurry that flows through the inside of the solid-liquid separator 42, so that the slurry comes to have a temperature within that range during the period when it is passing through the solid-liquid separator 42. Therefore, the period of heating in the solid-liquid separator 42 is not particularly limited, but it is, for example, 10 minutes or more and 120 minutes or less. Meanwhile, the temperature of the slurry before passing through the heater 41 is about 100° C. It is therefore preferable that the heater 41 should be one which is capable of heating the solvent at a heating rate of about 3° C. or more and 100° C. or less per minute.

### (Solid-Liquid Separator)

The slurry obtained by mixing in the preparation tank 31 is caused to flow into the solid-liquid separator 42, in which a solution containing coal components dissolved therein is separated by filtration, and a high-solid-content liquid containing solvent-insoluble components is discharged. The term “solvent-insoluble components” herein means a dissolution residue which is constituted mainly of ash matter insoluble in solvent and insoluble coal and which further contains the solvent used for the dissolution.

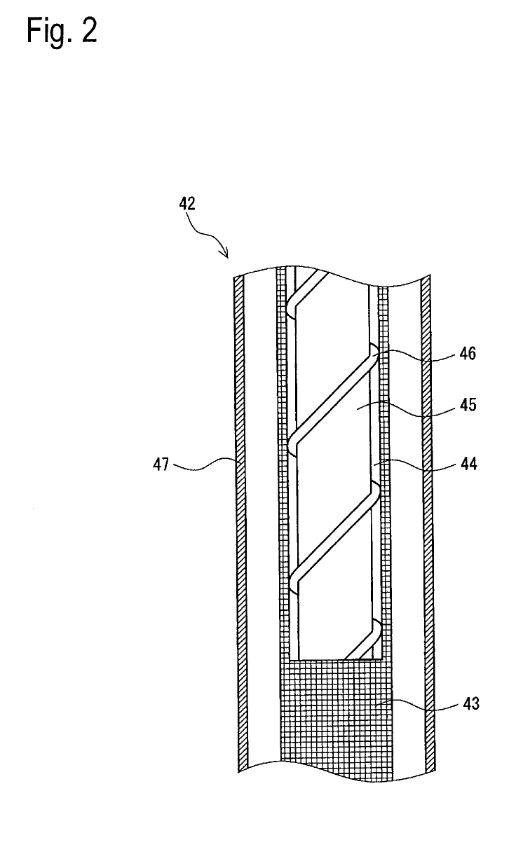

The solid-liquid separator 42 is cylindrical and is disposed upright so that the center axis thereof is parallel with the vertical direction. As illustrated in FIG. 2, the solid-liquid separator 42 includes a filter cylinder 43, a helical channel 44 disposed along the inner side surface of the filter cylinder 43, and a recovery pipe 47 including the filter cylinder 43 thereinside. The helical channel 44 is constituted of a core material 45 disposed in the filter cylinder 43 coaxially therewith and a helical guide 46 disposed between the inner wall of the filter cylinder 43 and the core material 45 helically along the axial direction. The slurry flows into an upper part of the solid-liquid separator 42 and passes through the helical channel 44.

The filter cylinder 43 constitutes the outer wall of the helical channel 44 and separates a solution containing coal components dissolved therein, by filtration from the slurry flowing through the helical channel 44. The separated solution flows out from the filter cylinder 43.

The filter cylinder 43 is not particularly limited so long as the solution containing coal components dissolved therein can be separated from the slurry therewith. Use can be made of a meshy one including metal wires, ceramic wires, etc. or nonwoven fabric. Preferred of these is a meshy one including metal wires. In the cases when a meshy one including metal wires is used, the filter is less apt to suffer clogging and no supporting material such as a reinforcing wire is required. Consequently, a solution containing coal components dissolved therein can be easily and reliably separated. From the standpoint of corrosion prevention, preferred is one using a stainless steel (in particular, SUS316) as the metal wires.

In the case where a meshy one including metal wires is used as the filter cylinder 43, a lower limit of the nominal mesh opening size is preferably 0.5 μm, more preferably 1 μm. An upper limit of the nominal mesh opening size is preferably 30 μm, more preferably 20 μm. In the case where the nominal mesh opening size is less than the lower limit, there is a possibility that the filter might be clogged. Meanwhile, in the case where the nominal mesh opening size exceeds the upper limit, there is a possibility that coal components other than the solvent-soluble components might pass through the filter cylinder 43.

The core material 45 is columnar and is disposed inside the filter cylinder 43 coaxially therewith. The core material 45 constitutes the inner wall of the helical channel 44.

The material of the core material 45 is not particularly limited, and use can be made of a metal, ceramic, or the like.

The helical guide 46 is in the shape of a wire. The helical guide 46 disposed between the inner wall of the filter cylinder 43 and the core material 45 so as to be helically wound around the core material 45 along the axial direction and be in contact with both the inner wall of the filter cylinder 43 and the core material 45. A helical channel 44 is thus formed between a portion of the helical guide 46 and another portion of the helical guide 46 which faces said portion.

The material of the helical guide 46 is not particularly limited. For example, it can be the same as the material of the core material 45. In the case when the material of the helical guide 46 is the same as the material of the core material 45, the core material 45 and the helical guide 46 can be monolithically formed.

The average diameter (wire diameter) of the helical guide 46 is the same as the width of the helical channel 44, and is equal to a half of the difference between the inner diameter of the filter cylinder 43 and the diameter of the core material 45.

The minimum distance (helix spacing) between a portion of the helical guide 46 and another portion of the helical guide 46 which faces said portion is substantially constant throughout the whole helical channel 44.

A lower limit of the linear flow velocity of the slurry that passes through the helical channel 44 is preferably 0.5 m/s, more preferably 1 m/s. An upper limit of the linear flow velocity is preferably 20 m/s, more preferably 10 m/s. In the case where the linear flow velocity is less than the lower limit, there is a possibility that shear force within the solid-liquid separator 42 might decrease, resulting in the clogging of the filter cylinder 43. Meanwhile, in the case where the linear flow velocity exceeds the upper limit, there is a possibility that the shear force within the solid-liquid separator 42 might be too high, resulting in erosion.

The solution which contains solvent-soluble components dissolved therein and which has been separated from the slurry while passing through the helical channel 44 and has flowed out from the filter cylinder 43 is recovered by means of the recovery pipe 47. Meanwhile, the high-solid-content liquid containing solvent-insoluble components passes through the helical channel 44 and is then discharged from a downstream side of the solid-liquid separator 42.

The material of the recovery pipe 47 for recovering the solution is not particularly limited, and use can be made of a metal, ceramic, or the like.

The recovery pipe 47 has a recovery hole 48. This recovery hole 48 is a hole for taking out therethrough the solution containing coal components dissolved therein. To the recovery hole 48 is connected a pipeline leading to the first solvent separation part 50.

It is desirable that the recovery pipe 47 should have the recovery hole 48 in the side face thereof at an upstream side of the helical channel 44, as illustrated in FIG. 1. The solution has a higher temperature in the downstream side. By thus disposing the recovery hole 48 in the side face at an upstream side of the helical channel 44, the solution in the downstream side, which has a higher temperature, is recovered while moving toward the upstream side of the helical channel 44. Because of this, heat exchange occurs between this solution and the slurry passing through the helical channel 44, making it possible to improve the efficiency of heating the slurry passing through the helical channel 44.

A lower limit of the internal pressure of the solid-liquid separator 42 is preferably 1.4 MPa, more preferably 1.7 MPa. An upper limit of the internal pressure of the solid-liquid separator 42 is preferably 3 MPa, more preferably 2.3 MPa. In the case where the internal pressure of the solid-liquid separator 42 is less than the lower limit, there is a possibility that solvent vaporization might render separation of the solution difficult. Meanwhile, in the case where the internal pressure of the solid-liquid separator 42 exceeds the upper limit, this solid-liquid separator 42 is required to be designed to have a high pressure resistance and there is hence a possibility of resulting in an increase in the cost of producing the solid-liquid separator 42. The “internal pressure of the solid-liquid separator” is the internal pressure of the recovery pipe 47 of the solid-liquid separator 42.

An upper limit of the difference (filtration pressure) between the slurry feeding pressure at the inflow port of the helical channel 44 and the pressure on the outer side face side of the filter cylinder 43 is preferably 1 MPa. In the case where the filtration pressure exceeds the upper limit, there is a possibility that the filter cylinder 43 might deform.

The period over which the slurry passes through the solid-liquid separator 42 is not particularly limited so long as a time period required for the slurry to be heated by the heater 41 and for solvent-soluble components to be dissolved away in the solvent is ensured. For example, it can be 10 minutes or more and 120 minutes or less. Consequently, the flow velocity of the slurry in the solid-liquid separator 42 can be 30 mm/min or more and 100 mm/min or less.

The ash-free coal production apparatus 1 can discharge a solution containing solvent-soluble components through the recovery hole 48 and can discharge a high-solid-content liquid containing solvent-insoluble components from a downstream side of the solid-liquid separator 42, while continuously supplying the slurry to the inside of the solid-liquid separation part 40. Thus, a continuous solid-liquid separation treatment is possible.

### <First Solvent Separation Part>

In the first solvent separation part 50, the solvent is separated by vaporization from the solution separated in the solid-liquid separation part 40, thereby obtaining an ash-free coal (HPC).

As a method for separating the solvent by vaporization, use can be made of separation methods including general distillation methods and vaporization methods (e.g., spray drying method). The solvent which has been separated and recovered can be circulated to a pipeline upstream from the preparation tank 31 and used repeatedly. By the separation and recovery of the solvent from the solution, an ash-free coal containing substantially no ash matter can be obtained from the solution.

The ash-free coal thus obtained contains ash matter in an amount of 5% by mass or less or of 1% by mass or less, i.e., contains substantially no ash matter, and contains completely no moisture. The ash-free coal shows a higher calorific value than, for example, the raw material coal. Furthermore, this ash-free coal has greatly improved softening and melting characteristic, which is an especially important quality as raw materials for steelmaking cokes, and for example, it shows far higher flowability than the raw material coal. Consequently, this ash-free coal can be used as a blending coal for raw materials for cokes.

### <Second Solvent Separation Part>

In the second solvent separation part 60, the solvent is separated by vaporization from the high-solid-content liquid separated in the solid-liquid separation part 40, thereby obtaining a by-product coal (RC).

As a method for separating the solvent from the high-solid-content liquid, use can be made of general distillation methods and vaporization methods (e.g., spray drying method) as in the methods for separation in the first solvent separation part 50. The solvent which has been separated and recovered can be circulated to a pipeline upstream from the preparation tank 31 and used repeatedly. By the separation and recovery of the solvent, a by-product coal in which solvent-insoluble components including ash matter, etc. have been concentrated can be obtained from the high-solid-content liquid. The by-product coal does not show softening and melting characteristic, but oxygen-containing functional groups have been eliminated therefrom. Consequently, this blending coal can be used as some of blending coals as a raw material for cokes. The blending coal may be discarded without being recovered.

### <Method for Producing Ash-Free Coal>

The method for producing an ash-free coal includes a step of feeding a solvent (solvent feed step), a step of feeding a coal (coal feed step), a step of mixing the coal with the solvent to thereby prepare a slurry (preparation step), a step of dissolving away coal components soluble in the solvent, from the coal, by heating the slurry (dissolution step), a step of separating a solution containing the coal components dissolved therein, from the slurry after the dissolution (separation step), a step of subjecting the solution separated in the separation step to vaporization and separation of the solvent, thereby obtaining an ash-free coal (ash-free coal acquisition step), and a step of subjecting the high-solid-content liquid separated in the separation step to vaporization and separation of the solvent, thereby obtaining a by-product coal (by-product coal acquisition step). An explanation is given below on this method for ash-free coal production in which the ash-free coal production apparatus 1 of FIG. 1 is used.

### (Solvent Feed Step)

In the solvent feed step, a solvent is fed to the preparation part 30. Specifically, a solvent stored in the solvent tank 11 is compression-transported with the pump 12 to the preparation part 30 through a feed pipe 70.

### (Coal Feed Step)

In the coal feed step, a coal stored in the coal feed part 20 is fed to the preparation part 30. Here, the coal is fed to the preparation part 30 while keeping the inside of the pressure hopper 22 in a pressurized state, in order that the solvent can be smoothly fed into the feed pipe 70 connected to the preparation part 30.

### (Preparation Step)

In the preparation step, the solvent and coal which have been fed in the solvent feed step and coal feed step described above are mixed together by means of the preparation tank 31 to obtain a slurry.

### (Dissolution Step)

In the dissolution step, the slurry is heated to thereby dissolve away solvent-soluble coal components from the coal. Specifically, the slurry passing through the helical channel 44 within the solid-liquid separator 42 is heated with the heater 41 to dissolve away soluble coal components into the solvent.

### (Separation Step)

In the separation step, a solution containing the coal components dissolved therein is separated from the slurry after the dissolution. This step is continuously performed simultaneously with temperature rinsing in the dissolution step. Specifically, a solution which contains coal components dissolved therein and which is being heated in the dissolution step is filtered with the filter cylinder 43 and separated into the recovery pipe 47. The separated solution is recovered through the recovery hole 48. Meanwhile, a high-solid-content liquid containing solvent-insoluble components remains in the filter cylinder 43, and is discharged from a downstream side of the solid-liquid separator 42.

### (Ash-Free Coal Acquisition Step)

In the ash-free coal acquisition step, an ash-free coal is obtained, by vaporization and separation, from the solution separated in the separation step. Specifically, the solution separated in the solid-liquid separation part 40 is supplied to the first solvent separation part 50, and the solvent is vaporized in the first solvent separation part 50 to perform separation into the solvent and an ash-free coal.

### (By-Product Coal Acquisition Step)

In the by-product coal acquisition step, a by-product coal is obtained, by vaporization and separation, from the high-solid-content liquid separated in the separation step. Specifically, the high-solid-content liquid separated in the solid-liquid separation part 40 is supplied to the second solvent separation part 60, and the solvent is vaporized in the second solvent separation part 60 to perform separation into the solvent and a by-product coal.

### <Advantages>

In this method for ash-free coal production, since the separation step is performed simultaneously with the dissolution step, the polymerization of solvent-soluble components due to temperature elevation in the separation step is less apt to occur and the dissolved amount of solvent-soluble components can be increased in the dissolution step. Consequently, this method for producing an ash-free coal is capable of heightening the extraction rate of ash-free coal.

In addition, since the separation step in this method for ash-free coal production is performed during the temperature rising in the dissolution step, the polymerization of solvent-soluble components due to temperature elevation can be more inhibited and the extraction rate of ash-free coal is further heightened.

Furthermore, since the separation step in this method for ash-free coal production is performed as a continuous treatment, the solvent-soluble components are not made to stay in a reservoir tank or the like and the polymerization of solvent-soluble components due to temperature elevation can be more inhibited. Hence, the extraction rate of ash-free coal is further heightened.

Moreover, in this method for ash-free coal production, by using the solid-liquid separator 42 in the separation step, the apparatus to be used in the separation step can be simplified and the cost for the apparatus for producing an ash-free coal can be reduced. Furthermore, since a solution containing coal components dissolved therein is separated by filtration through the filter cylinder 43, ash matter concentration of an ash-free coal obtained can be reduced.

### Second Embodiment

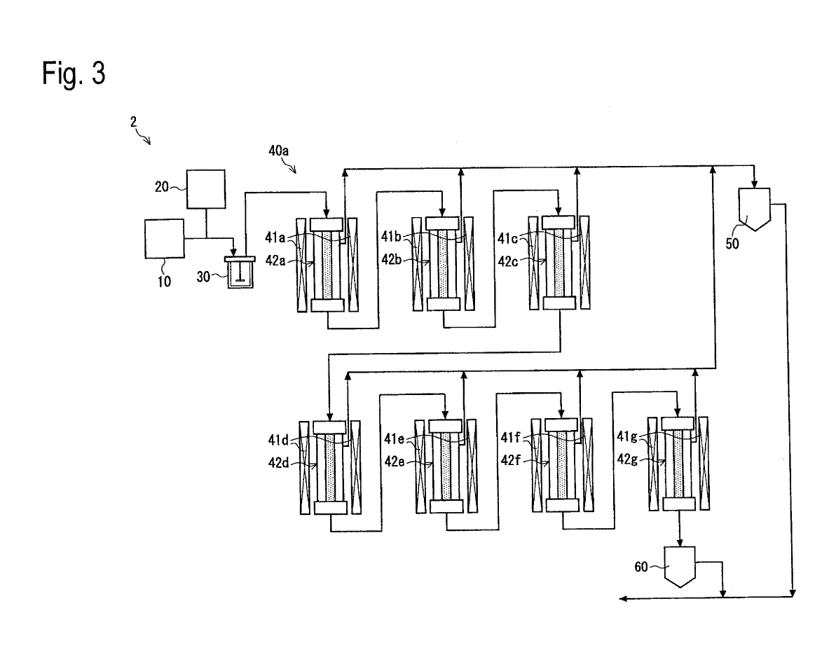

An ash-free coal production apparatus 2 of FIG. 3 includes seven solid-liquid separators 42a to 42g connected serially, as a solid-liquid separation part 40a. This ash-free coal production apparatus 2 has the same configuration as the ash-free coal production apparatus 1 of FIG. 1, except for the solid-liquid separation part 40a. Hence, the parts or portions other than the solid-liquid separation part 40a are designated by the same numerals or sings, and explanations thereon are omitted.

### <Solid-Liquid Separation Part>

The solid-liquid separation part 40a includes seven stages of solid-liquid separators 42a to 42g connected serially and heaters 41a to 41g corresponding to the solid-liquid separators 42a to 42g, respectively.

### (Heaters)

As each of the plurality of heaters 41a to 41g, use can be made of a heater similar to the heater 41 in the first embodiment.

A lower limit of the temperature of the slurry after heating by the heater 41a (first-stage heater 41a) for heating the first-stage solid-liquid separator 42a is preferably 90° C., more preferably 95° C. Meanwhile, an upper limit of the temperature of the slurry by means of the first-stage heater 41a is preferably 110° C., more preferably 105° C. In the case where the temperature of the slurry by means of the first-stage heater 41g is below the lower limit, there is a possibility that the amount of coal components dissolved might be exceedingly small, resulting in a decrease in the dissolution rate. Conversely, in the case where the temperature of the slurry by means of the first-stage heater 41a exceeds the upper limit, there is a possibility that the amount of coal components dissolved in the first stage might be too large, resulting in an insufficient improvement in the effect of inhibiting the polymerization of solvent-soluble components by the multistage treatment.

A lower limit of the temperature of the slurry after heating by the heater 41g (final-stage heater 41g) for heating the final-stage solid-liquid separator 42g is preferably 300° C., more preferably 350° C. Meanwhile, an upper limit of the temperature of the slurry by means of the final-stage heater 41g is preferably 420° C., more preferably 400° C. In the case where the temperature of the slurry by means of the final-stage heater 41g is below the lower limit, there is a possibility that the bonds between the molecules constituting the coal cannot be sufficiently weakened, resulting in a decrease in the degree of dissolution. Conversely, in the case where the temperature of the slurry by means of the final-stage heater 41g exceeds the upper limit, there is a possibility that pyrolysis radicals yielded by pyrolysis reactions of the coal undergo recombination, resulting in a decrease in the dissolution rate.

The heating temperatures at which the heaters 41a to 41g respectively heat the solid-liquid separators 42a to 42g are set for each solid-liquid separator so that they rise toward the downstream side. The heating temperature for each stage of the heaters 41a to 41g can be a temperature which is higher by, for example, 45° C. or more and 55° C. or less than that for the preceding stage.

### (Solid-Liquid Separators)

The slurry obtained by mixing in the preparation tank 31 is caused to flow into the first-stage solid-liquid separator 42a from the upstream side, in which a solution containing coal components dissolved therein is separated by filtration, and a high-solid-content liquid containing solvent-insoluble coal components concentrated is discharged from the downstream side. The high-solid-content liquid discharged from the preceding solid-liquid separator is caused to flow into each of the second-stage to final-stage (seventh-stage) solid-liquid separators 42b to 42g from the upstream side, in which a solution containing coal components dissolved therein is separated by filtration, and a high-solid-content liquid containing solvent-insoluble coal components concentrated is discharged from the downstream side. Thus, the seven-stage solid-liquid separators 42a to 42g are connected serially.

The solutions separated by each stage of the solid-liquid separators 42a to 42g flow into the first solvent separation part 50, while the high-solid-content liquid discharged from the final stage (seventh-stage) solid-liquid separator 42g flows into the second solvent separation part 60.

Each of the solid-liquid separators 42a to 42g can have configuration and dimensions similar to that of the solid-liquid separator 42 of the first embodiment.

### <Method for Producing Ash-Free Coal>

The method for producing an ash-free coal, in which the ash-free coal production apparatus 2 of FIG. 3 is used, is explained below. The solvent feed step, coal feed step, preparation step, ash-free coal acquisition step, and by-product coal acquisition step are the same as in the case of using the ash-free coal production apparatus 1 of FIG. 1. Explanations thereon are hence omitted.

### (Dissolution Step and Separation Step)

In this method for ash-free coal production, the separation step is performed simultaneously with the dissolution step. First, as for a slurry which has flowed into the first-stage solid-liquid separator 42a, solvent-soluble coal components are dissolved away from the coal by means of the first-stage heater 41a, and a solution which contains the coal components dissolved therein and which is being heated is filtered with the filter cylinder 43 and separated into the recovery pipe 47. Meanwhile, a high-solid-content liquid containing components which are insoluble in the solvent at the heating temperature for the heater 41a remains in the filter cylinder 43, and is discharged from a downstream side of the first-stage solid-liquid separator 42a.

Next, the high-solid-content liquid discharged from the first-stage solid-liquid separator 42a is caused to flow into the second-stage solid-liquid separator 42b. As in the first stage, solvent-soluble coal components are dissolved away from the coal by the second-stage heater 41b, and a solution which contains the coal components dissolved therein and which is being heated is filtered with the filter cylinder 43 and separated into the recovery pipe 47. Here, since the heating temperature for the second-stage heater 41b is higher than the heating temperature for the first-stage heater 41a, it is possible to separate coal components which are insoluble at the first-stage heating temperature but are soluble at the second-stage heating temperature. Furthermore, since the coal components which are soluble in the first stage have been separated by the first-stage solid-liquid separator 42a, the coal components newly dissolved away in the second stage can be prevented from polymerizing with the coal components which have been dissolved away in the first stage.

Likewise, the high-solid-content liquid from the preceding stage is caused to flow into each of the third-stage to seventh-stage solid-liquid separators 42c to 42g and heated to a higher temperature than in the preceding stage. Thus, solutions containing coal components dissolved therein are successively separated.

### <Advantages>

In this method for ash-free coal production in which the ash-free coal production apparatus 2 of FIG. 3 is used, since a heating temperature of the solid-liquid separators 42a to 42g is set for each of the solid-liquid separators, components dissolved away in each of the solid-liquid separators 42a to 42g can be varied. Because of this, by this method for ash-free coal production in which the ash-free coal production apparatus 2 is used, components differing in molecular weight distribution, components differing in softening point or meltability, and the like can be easily separated and obtained.

Furthermore, in this method for ash-free coal production in which the ash-free coal production apparatus 2 is used, since the heating temperatures for the plurality of solid-liquid separators 42a to 42g are made to rise toward the downstream side, coal components soluble in the solvent at each of the heating temperatures can be successively separated. The polymerization of the solvent-soluble components can hence be more inhibited, and the extraction rate of ash-free coal is further heightened.

### OTHER EMBODIMENTS

The method of the present invention for producing an ash-free coal is not limited to the embodiments described above.

In the embodiments described above, the cases are explained where the solid-liquid separators is disposed upright so that the center axes thereof is parallel with the vertical direction. However, the disposition in which the center axis of the solid-liquid separator is parallel with the vertical direction is not essential. For example, the solid-liquid separator may be disposed so that the center axis thereof is parallel with a horizontal direction.

Furthermore, in the embodiments described above, the cases are explained where the slurry flows in from an upper part of the solid-liquid separator. However, the method may have a configuration in which the slurry flows in from a lower part of the solid-liquid separator.

In the embodiments described above, the cases are explained where the recovery pipe has a recovery hole in the side face thereof at an upstream side of the helical channel. However, a recovery hole may be provided in another position, for example, in the side face at a downstream side of the helical channel.

In the embodiments described above, the separation step is performed during the temperature rising in the dissolution step, but it may be performed just after temperature rising. Examples of methods for performing just after temperature rising include a method in which the slurry is heated, for example, with a preheater just before flowing into the solid-liquid separator. In this case, the solid-liquid separation part may be equipped with a temperature-holding device for keeping the solid-liquid separator at a temperature for dissolution, in place of the heater.

In the embodiments described above, the solid-liquid separator equipped with a filter cylinder and a helical channel disposed along the inner side surface of the filter cylinder is used in the separation step. However, other solid-liquid separators may be used. Examples of the other solid-liquid separators include centrifugal separators and separators based on the gravitational settling method.

In the embodiments described above, the method in which the separation step is performed as a continuous treatment is explained. However, the separation step may be performed not as a continuous treatment but as a batch treatment in which a slurry is, for example, retained in a solid-liquid separator to conduct separation and this operation is repeated.

Furthermore, in the second embodiment described above, the case is explained where seven-stage solid-liquid separators are connected serially. However, the number of stages to be connected serially is not limited to seven stages, and it may be a serial connection of two stages or more and six stages or less, or of eight stages or more.

Moreover, a configuration may be employed in which one solid-liquid separator is used and the heating temperature is made to rise toward the downstream side along the helical channel. The configuration in which the heating temperature is made to rise toward the downstream side along the helical channel can be achieved, for example, by using a plurality of heaters disposed serially along the helical channel and regulating the heating temperatures for the heaters so that they rise toward the downstream side.

In the second embodiment, the heating temperatures for the plurality of solid-liquid separators are regulated so as to rise toward the downstream side. However, a solid-liquid separator having a temperature equal to or lower than that of the upstream may be included.

In the second embodiment, the high-solid-content liquid discharged from the preceding solid-liquid separator is caused to flow into each of the second-stage to final-stage solid-liquid separators. However, a solution obtained by adding a solvent to the high-solid-content liquid to regulate the concentration of the slurry may be caused to flow thereinto.

Furthermore, in the embodiments described above, a configuration where the preparation part has a preparation tank is explained. However, the configuration is not limited thereto, and the preparation tank may be omitted so long as the solvent and the coal can be mixed together. For example, in the cases when the mixing is completed with a line mixer, the preparation tank may be omitted to employ a configuration in which a line mixer is provided between the feed pipe and the solid-liquid separation part.

Moreover, the coal feed part is not limited to the configuration described above, and may have another configuration so long as the coal can be smoothly fed into the feed pipe while preventing the solvent from reversely flowing from the feed pipe to the coal feed part.

While the present invention has been described in detail and with reference to specific embodiments thereof, it will be apparent to one skilled in the art that various changes and modifications can be made therein without departing from the spirit and scope of the present invention.

The present application is based on a Japanese patent application (Application No. 2015-044799) filed on Mar. 6, 2015, the content thereof being incorporated herein by reference.

### INDUSTRIAL APPLICABILITY

As explained above, according to this method for ash-free coal production, the extraction rate of ash-free coal can be heightened by performing the separation step simultaneously with the dissolution step. This method is hence suitably used as a method for obtaining an ash-free coal from a coal.

### DESCRIPTION OF THE REFERENCE NUMERALS AND SINGS

1, 2 Ash-free coal production apparatus
10 Solvent feed part
11 Solvent tank
12 Pump
20 Coal feed part
21 Normal-pressure hopper
22 Pressure hopper
23 First valve
24 Second valve
25 Pressurization line
26 Gas discharge line
30 Preparation part
31 Preparation tank
31a Stirrer
40, 40a Solid-liquid separation part
41, 41a, 41b, 41c, 41d, 41e, 41f, 41g Heater
42, 42a, 42b, 42c, 42d, 42e, 42f, 42g Solid-liquid separator
43 Filter cylinder
44 Helical channel
45 Core material
46 Helical guide
47 Recovery pipe
48 Recovery hole
50 First solvent separation part
60 Second solvent separation part
70 Feed pipe

1. A method for producing an ash-free coal, the method comprising:
mixing a coal with a solvent to thereby prepare a slurry;
dissolving away a coal component soluble in the solvent, from the coal, by heating the slurry;
separating a solution comprising the coal component dissolved therein, from the slurry; and
subjecting the solution obtained after said separating to a vaporization and a separation to remove the solvent to obtain an ash-free coal,
wherein said dissolving and said separating are simultaneously performed.

2. The method according to claim 1, wherein said separating is performed during a temperature rising in said dissolving.

3. The method according to claim 1, wherein said separating step is performed as a continuous treatment.

4. The method according to claim 3, wherein in said separating, a solid-liquid separator equipped with a filter cylinder and a helical channel disposed along an inner side surface of the filter cylinder is used.

5. The method according to claim 4, wherein the filter cylinder is a meshy filter cylinder comprising a metal wire.

6. The method according to claim 4,
wherein the solid-liquid separator is further equipped with a recovery pipe that includes the filter cylinder and recovers the solution, and
wherein the recovery pipe has a recovery hole, which discharges the solution, in a side face thereof at an upstream side of the helical channel.

7. The method according to claim 4, wherein a plurality of the solid-liquid separators connected serially is used and a heating temperature of the plurality of solid-liquid separators is set for each of the solid-liquid separators.

8. The method according to claim 7, wherein the heating temperature of the plurality of solid-liquid separators is set to be higher toward a downstream side.
